(19) United States
(12) Patent Application Publication
(10) Pub. No.: US 2012/0111708 A1
(43) Pub. Date: May 10, 2012

(54) SWITCH DEVICE

(75) Inventor: Satoru Matsumoto, Chiba (JP)

(73) Assignee: SEIKO PRECISION INC., Chiba (JP)

(21) Appl. No.: 13/288,640

(22) Filed: Nov. 3, 2011

(30) Foreign Application Priority Data
Nov. 4, 2010 (JP) 2010-247599

(51) Int. Cl. H01H 13/76

(52) U.S. Cl. 200/5 A

(57) ABSTRACT

A first operation portion and a second operation portion are depressed in a direction orthogonal to a surface of an electronic circuit board, at least the first operation portion is shifted relative to the center of a first switch, and travel distances or depression forces of a depression operation necessary for respective first and second protrusions to reach respective first and second depression faces are equal to each other.

### CROSS-REFERENCE TO RELATED APPLICATION

This application claims the benefit of Japanese Patent Application No. 2010-247599, filed on Nov. 4, 2010, the entire disclosure of which is incorporated by reference herein.

### FIELD

This application relates generally to a switch device.

### BACKGROUND

Typical switch devices include a substrate on which switches are disposed and a cover having operation buttons disposed so as to match the layout of the switches.

As shown in FIGS. 9A and 9B, each operation button 60 has an operation portion 63 formed on the front face and a protrusion 62 formed on the rear face. When a user depresses the operation portion 63, depression force is applied to a switch 61 through the protrusion 62.

According to the above-explained configuration, it is necessary to dispose the operation button 60 on a cover 70 so as to be placed on the vertical line of the switch 61 on the substrate. That is, once the position of the switch 61 on the substrate is set, the position of the operation button 60 on the cover 70 is also set, resulting in a restriction of the degree of freedom for designing.

Regarding such a technical issue, Unexamined Japanese Patent Application KOKAI Publication No. 2006-302668 discloses a switch device that has a driving portion which is shifted from the center of the operation portion and which applies depression force to the switch, thereby allowing a placement of the operation button with an enhanced design property.

Since the switch device disclosed in Unexamined Japanese Patent Application KOKAI Publication No. 2006-302668 places the driving portion shifted from the center of the operation portion, necessary depression force and travel distance (a displacement of the operation button from a non-depressed state to a depressed state) vary for each operation button, and thus the user feels strangeness when operating the switches.

### SUMMARY

The present invention has been made in view of the above-explained circumstance, and it is an object of the present invention to provide a switch device that allows a user to depress, for example, two operation buttons, without a feeling of strangeness therebetween when the operation buttons are laid out with an enhanced design property.

In order to achieve the above object, a switch device according to an aspect of the present invention includes: an electronic circuit board comprising an electronic circuit including a first switch and a second switch; and a cover which covers the electronic circuit board and which includes a first operation button and a second operation button corresponding to the first switch and the second switch, respectively, the first switch including a first depression face to which a first depression force is applied in a direction orthogonal to a surface of the electronic circuit board, and the first switch being configured to change an electrical connection in the electronic circuit when a predetermined depression force is applied to the first depression face, the second switch including a second depression face to which a second depression force is applied in a direction orthogonal to the surface of the electronic circuit board, and the second switch being configured to change an electrical connection in the electronic circuit when the predetermined depression force is applied to the second depression face, the first operation button including: a first support point integrated with the cover; a first operation portion to which a depression operation is given by a user; a first tiltable portion which has one end connected to the first support portion, has another end connected to the first operation portion, and is tilted together with the first operation portion in accordance with the depression operation given to the first operation portion; and a first protrusion that depresses the first depression face upon tilting of the first tiltable portion, the second operation button including: a second support point integrated with the cover; a second operation portion to which a depression operation is given by the user; a second tiltable portion which has one end connected to the second support portion, has another end connected to the second operation portion, and is tilted together with the second operation portion in accordance with the depression operation given to the second operation portion; and a second protrusion that depresses the second depression face upon tilting of the second tiltable portion, the first and second operation portions being depressed in a direction orthogonal to the surface of the electronic circuit board, at least the first operation portion being shifted relative to a center of the first switch, and travel distances or depression forces of the depression operation necessary for respective first and second protrusions to reach respective first and second depression faces being equal to each other.

The first tiltable portion and the second tiltable portion may have different lengths, and respective dimensions of the first and second protrusions along a direction orthogonal to the surface of the electronic circuit board may differ in accordance with the length of the first tiltable portion and the length of the second tiltable portion.

A shifted level of the first protrusion from a center of the first depression face and a shifted level of the second protrusion from a center of the second depression face may be equal to each other.

A tip of the first protrusion may be formed in an inclined surface so as to abut the depression face in parallel therewith when depressing the depression face.

Respective tips of the first and second protrusions may be rounded.

### BRIEF DESCRIPTION OF THE DRAWINGS

A more complete understanding of this application can be obtained when the following detailed description is considered in conjunction with the following drawings, in which:

FIG. 1A is an exploded perspective view showing a switch device according to an embodiment of the present invention;

FIG. 1B is a front view of the switch device according to the embodiment of the present invention;

FIG. 2A is a diagram showing an operation of an operation button according to the embodiment of the present invention;

FIG. 2B is a diagram showing an operation of the operation button according to the embodiment of the present invention;

FIG. 3 is a diagram showing a travel path of the operation button according to the embodiment of the present invention;

FIG. 4 is a cross-sectional view showing a switch device according to a first embodiment of the present invention;

FIG. 5A is an enlarged view of an operation button according to the first embodiment of the present invention;

FIG. 5B is an enlarged view of the operation button according to the first embodiment of the present invention;

FIG. 6 is an enlarged view of a front face of a switch device according to a second embodiment of the present invention;

FIG. 7A is an enlarged view of an operation button according to the second embodiment of the present invention;

FIG. 7B is an enlarged view of the operation button according to the second embodiment of the present invention;

FIG. 8A is a diagram showing a modified example of an operation button according to the first and second embodiments of the present invention;

FIG. 8B is a diagram showing another modified example of the operation button according to the first and second embodiments of the present invention;

FIG. 9A is a diagram showing a front face of a prior-art switch device; and

FIG. 9B is a diagram showing a side face of the prior-art switch device.

### DETAILED DESCRIPTION

An explanation will be given of a switch device 1 according to an embodiment of the present invention with reference to the accompanying drawings. In the following embodiments, an XYZ Cartesian coordinate system is defined as follows. A direction in which operation buttons on a front-frame cover are laid out is defined as an X axis direction, a direction orthogonal to the X axis direction on the front-frame cover is defined as a Y axis direction, and a direction from the front-frame cover to a printed substrate is defined as a Z axis direction.

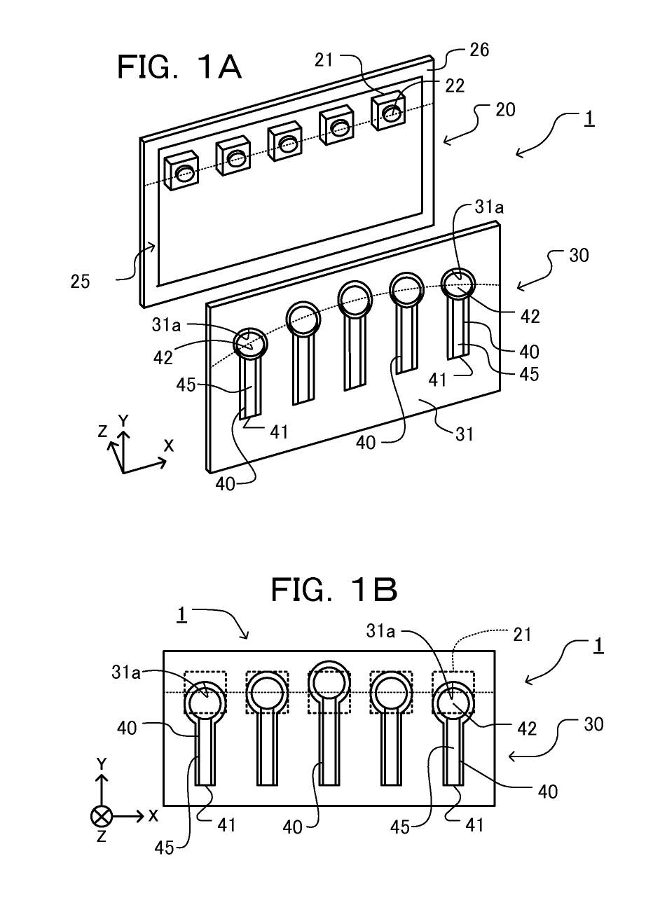

The switch device 1 includes, as shown in FIG. 1A, a printed substrate 20, and a front-frame cover 30.

The printed substrate 20 is formed in a tabular or film-like shape, and has an electronic circuit 25 (drawn exemplarily in the figure). More specifically, the printed substrate 20 includes, for example, a base member 26 formed in a substrate or film-like shape, and the electronic circuit 25 formed on the front face of the base member 26 (a face at the front-frame-cover-30 side). The electronic circuit 25 includes a large number of electronic components, such as switches 21, an integrated circuit, a resistor, and a capacitor, coupled together by wirings. The printed substrate 20 (the base member 26) has the front face impregnated by an insulative resin, and circuit wirings among respective electronic components are formed of a conductor like a copper foil.

The switch 21 is, for example, an electronic component which changes an electrical connection in the electronic circuit by opening/closing an electrical connection of an external element outside the switch 21 in the electronic circuit. The switches 21 are placed on the printed substrate 20, and are laid out side by side over a straight line parallel to the X axis. A switch depression surface 22 is provided at an upper part of the switch 21 in a protruding manner, and is depressed when predetermined depression force is applied thereto. When the switch depression surface 22 is depressed, the switch 21 opens/closes the electronic circuit.

The front-frame cover 30 is fixed to the printed substrate 20 by an arbitrary scheme like screws. The front-frame cover 30 covers the printed substrate 20, and is formed of a synthetic resin, etc., into a single piece. The front-frame cover 30 includes a front-frame-cover main body 31 and a plurality of operation buttons 40.

The operation buttons 40 each includes a support portion 41, an operation portion 42, and a tiltable portion 45. The operation buttons 40 each is disposed along the X axis on the front-frame cover 30 in order to allow a user to operate respective switches 21, and is integrated with the front-frame cover 31. Regarding each operation button 40, the operation portion 42 and tiltable portion 45 are surrounded by a through-hole 31a formed in the front-frame cover 31, and is displaceable since it is not coupled with the front-frame cover 31.

The tiltable portion 45 has one end and another end continuous from the support portion 41 and the operation portion 42, respectively. The tiltable portion 45 is tiltable in the Z axis direction with the support portion 41 being as a support point.

The support portion 41 is integral with the front-frame-cover main body 31. That is, the support portion 41 interconnects the tiltable portion 45 and the front-frame-cover main body 31 together. The operation button 40 is disposed so that the remaining portions (the operation portion 42 and the tiltable portion 45) are tilted in the Z axis direction with the support portion 41 being as a support point.

The operation portion 42 is a depressed portion when the user gives a depression operation thereto, and has a front face protruding from the front face of the operation button 40. When the user depresses the operation portion 42, the operation button 40 is tilted together with the tiltable portion 45 with the support portion 41 being as a support point, and is depressed in a direction toward the printed substrate 20, i.e., in the Z axis direction.

As shown in FIG. 1B, in order to enhance the design property of the switch device 1, the support portions 41 are laid out side by side over a straight line parallel to the X axis, and the operation portions 42 are disposed so as to be shifted in the Y axis direction. That is, as viewed from the Z axis direction (i.e., when viewed from the user), some of the operation portions 42 are disposed so as to be shifted from the center of respective switches 21 that are disposed in a regular manner in order to effectively utilize the area of the printed substrate 20. The expression that the operation portion 42 is shifted from the center of the switch 21 means, for example, as viewed from the Z axis direction, the center of the operation portion 42 is shifted (off-centered) from the center of the switch depression surface 22 of the switch 21. Moreover, an expression that the operation portion 42 is not shifted from the center of the switch 21 (i.e., a shifted level (a distance of the shifting as viewed from the Z axis direction (from the front-frame-cover-30 side) is zero) means, as viewed from the Z axis direction (from the front-frame-cover-30 side), the center of the operation portion 42 overlaps the center of the switch depression surface 22 of the switch 21 and is not shifted therefrom. In the present embodiment, the operation buttons 40 have different shifted levels of respective operation portions 42 from the center of respective switches 21. More specifically, in the case of FIG. 1B, the rightmost operation button 40 and the leftmost operation button 40 are shifted downwardly, the center operation button 40 is shifted upwardly, and other operation buttons 40 are not shifted. Accordingly, for example, the rightmost operation button 40 and the second operation button 40 from the right (or the center operation button 40) have different shifted levels.

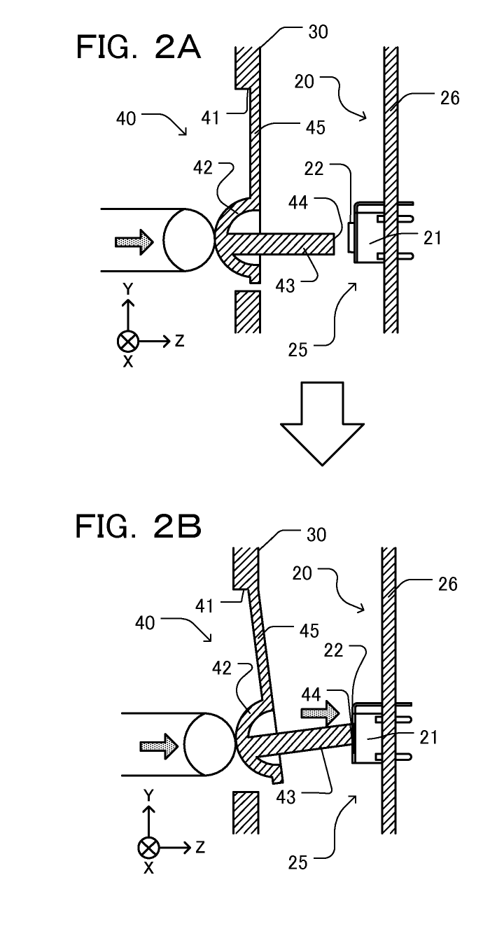

Next, an explanation will be given of the operation button 40 with reference to the cross-sectional view of the switch device 1. As shown in FIGS. 2A and 2B, the operation button 40 has a protrusion 43 provided on the rear face of the operation portion 42 in a protruding manner. The protrusion 43 is depressed in a direction toward the printed substrate 20, i.e., the Z axis direction upon application of depression force to the operation portion 42. That is, the protrusion 43 is depressed in the direction toward the printed substrate 20, i.e., the Z axis direction together with a tilting motion of the tiltable portion 45 (or a depression motion of the operation portion 42). The protrusion 43 is provided at the center of the operation portion 42, and when the operation portion 42 is shifted from the center of the switch 21, the protrusion 43 (or the center thereof) is also shifted from the switch 21.

A depression face 44 is a tip surface of the protrusion 43. When the protrusion 43 is depressed toward the printed substrate 20, the depression face 44 abuts a switch depression face 22, and applies depression force thereto, thereby depressing the switch depression face 22.

Next, an explanation will be given of an operation when the user depresses the operation button 40. How to operate the operation button 40 is common to all operation buttons 40.

First, as shown in FIG. 2A, the user depresses the operation portion 42. Upon this operation, the operation portion 42 and the tiltable portion 45 are tilted with the support potion 41 being as a support point, and the operation button 40 is depressed in the direction toward the printed substrate 20, i.e., the Z axis direction.

As the user depresses the operation portion 42, the protrusion 43 is simultaneously depressed, and eventually, as shown in FIG. 2B, the depression face 44 abuts the switch depression face 22. Furthermore, as depression force from the user is applied, the depression face 44 depresses the switch depression face 22. Accordingly, the switch 21 is operated. That is, an electrical connection is changed by the switch 21.

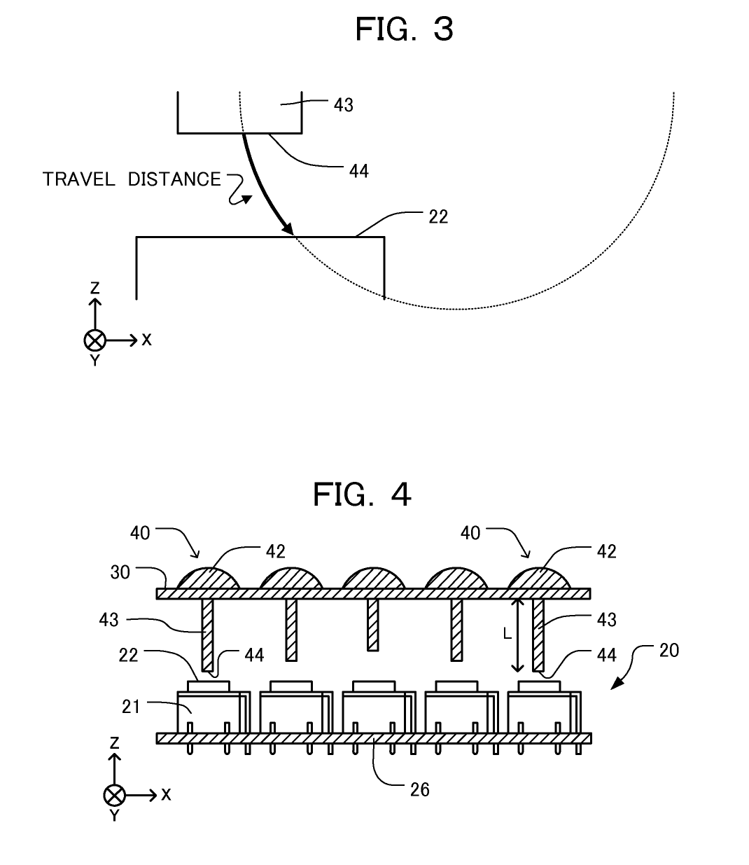

As shown in FIG. 3, the depression face 44 abuts and depresses the switch depression face 22 through a circular motion. This is because, as explained above, the operation portion 42 is depressed with the support portion 41 being as a support point. A length of an arc until the depression face 44 reaches the switch depression face 22 is referred to as a “travel distance”.

According to the present embodiment, all operation buttons 40 are respectively adjusted so that depression force or a travel distance necessary for the depression face 44 to reach the switch depression face 22 becomes equal throughout all operation buttons 40.

### First Embodiment

An explanation will now be given of the operation button 40 according to a first embodiment of the present invention with reference to the accompanying drawings.

As shown in FIG. 4, the operation buttons 40 respectively have the protrusions 43 having different dimensions L along the Z axis direction so that depression forces for allowing respective depression faces 44 to reach the switch depression faces 22 become equal to one another. For example, the longer the distance between the support portion 41 and the operation portion 42 becomes, the shorter the dimension L of the protrusion 43 becomes, and the shorter such a distance becomes, the longer the dimension L becomes. That is, the dimension L is adjusted in accordance with the length of the tiltable portion 45.

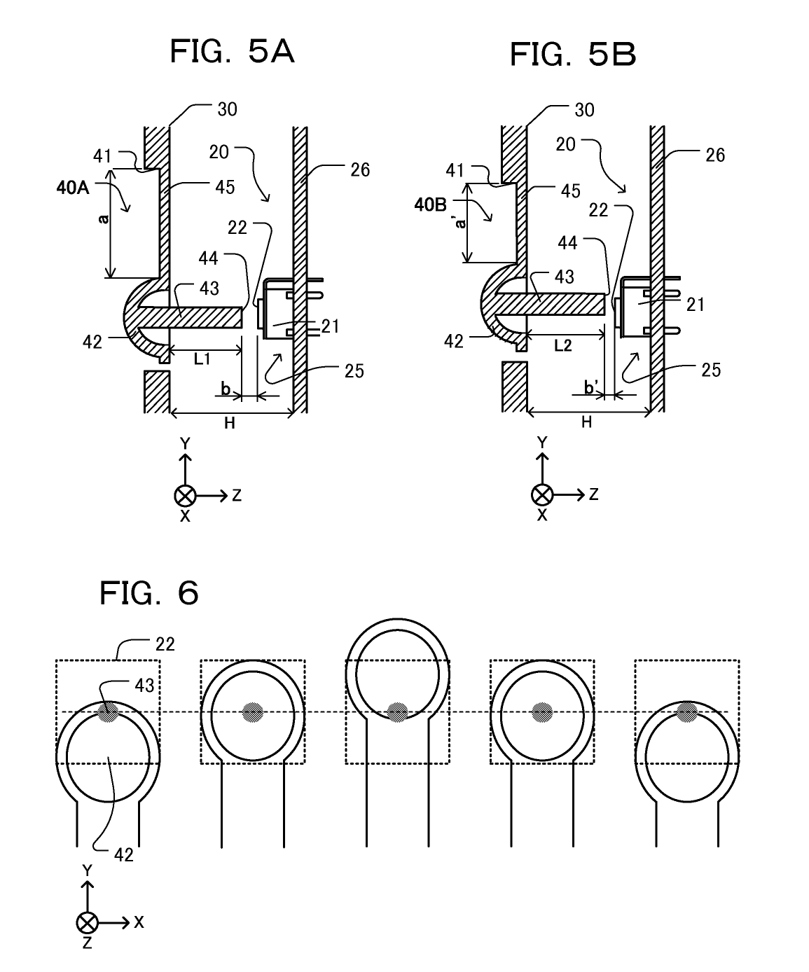

Regarding the dimension of the protrusion 43, an explanation will be given of examples that are an operation button 40A which has a distance a between the support portion 41 and the operation portion 42 and an operation button 40B which has a distance a′ between the support portion 41 and the operation portion 42 with reference to FIGS. 5A and 5B. Note that a≠a′ and a>a′.

In order to make respective depression forces for allowing the depression face 44 to reach the switch depression face 22 equal to each other, the dimensions of respective protrusions 43 are adjusted in accordance with the distances a and a′, which are L1 and L2 for the operation button 40A and the operation button 40B, respectively. Note that L1<L2.

Moreover, since dimensions L1 and L2 of respective protrusions 43 are different from each other, respective distances from the depression face 44 to the switch depression face 22 are also different from each other. Those distances are b for the operation button 40A and b′ for the operation button 40B and, b≠b′ and b>b′.

A distance from the front-frame cover 30 to the printed substrate 20 is H which is common to the operation buttons 40A and 40B.

A comparison will be given of cases in which the user depresses the operation button 40A and the operation button 40B, respectively. As explained above, since the relationship of the distances between the support portion 41 of each operation button 40 and the operation portion 42 is a>a′, the operation button 40A has such a distance longer than that of the operation button 40B. Hence, the operation button 40A allows the user to depress the operation portion 42 in the Z axis direction with smaller force.

If the relationship between the distance from the depression face 44 of each operation button 40 to the switch depression face 22 is b=b′, depression force necessary for allowing the depression face 44 to reach the switch depression face 22 differs for the operation button 40A and the operation button 40B.

That is, unless the user depresses the operation button 40B with larger force than depression force necessary for the operation button 40A, the depression face 44 of the operation button 40B cannot reach the switch depression face 22. When depression force necessary for an operation differs for each operation button 40 as explained above, the user feels strangeness.

In contrast, according to the present embodiment, respective dimensions L1 and L2 of the protrusions 43 of the operation buttons 40A and 40B are adjusted in order to change respective travel distances until the depression face 44 reaches the switch depression face 22, thereby making depression forces necessary for operating respective operation buttons 40 equal to one another.

That is, the operation button 40A has a larger distance b in order to increase depression force necessary for an operation, and the operation button 40B has a smaller distance b′ in order to decrease depression force necessary for an operation. At this time, the distances b and b′ are adjusted so that depression force necessary for operating the operation button 40A and depression force necessary for operating the operation button 40B become equal to each other.

Hence, even if the operation buttons 40 are laid out so as to be shifted from the centers of respective switches 21, the user can operate the operation buttons 40 without feeling any strangeness in operation originating from the difference among depression forces necessary for operating respective operation buttons 40.

In the present embodiment, the explanation was given of examples which are two operation buttons 40, but for all operation buttons 40, the dimension L of the protrusion 43 is adjusted based on the distance from the support portion 41 to the operation portion 42, and thus depression force necessary for allowing the depression face 44 to reach the switch depression face 22 is equal (including a case in which the depression force is substantially equal).

As explained above, according to the switch device 1 of the present embodiment, depression force is set to be equal for all operation buttons 40. Accordingly, even if the operation buttons 40 are laid out with the design property being enhanced, the user can operate the switch device 1 without feeling strangeness.

### Second Embodiment

Next, an explanation will be given of the operation button 40 according to a second embodiment of the present invention with reference to the accompanying drawings.

As shown in FIG. 6, respective operation buttons 40 have the protrusions 43 shifted from respective centers of the operation portions 42 in the Y axis direction so that respective travel distances until the depression face 44 reaches the switch depression face 22 become equal to one another. The protrusions 43 are disposed so that distances from respective support portions 41 to corresponding protrusions 43 (a distance from the center of the support portion 41 to the center of each protrusion 43) become equal for all operation buttons 40.

The protrusion 43 shown in FIG. 6 is provided on the rear face of the operation portion 42 in a protruding manner like the first embodiment. Unlike the first embodiment, however, the dimensions of the protrusions 43 are formed so as to be equal for all operation buttons 40.

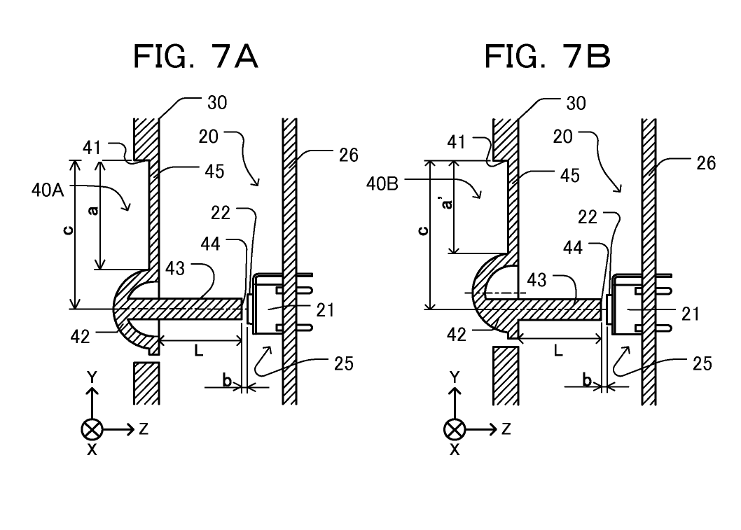

Regarding a position where the protrusion 43 is disposed, an explanation will be given of examples that are the operation button 40A which has a distance a between the support portion 41 and the operation portion 42 and the operation button 40B which has a distance a′ between the support portion 41 and the operation portion 42 with reference to FIGS. 7A and 7B. Note that a≠a′ and a>a′.

The protrusions 43 are disposed at positions where a distance between the support portion 41 and the protrusion 43 becomes equal to c in both cases of the operation buttons 40A and 40B.

In this case, the protrusion 43 of the operation button 40A is disposed near the center of the operation portion 42 and the protrusion 43 of the operation button 40B is disposed near the tip of the operation portion 42.

Since the dimension L of the protrusion 43 is equal for both of the operation buttons 40A and 40B, a distance from the depression face 44 to the switch depression face 22 becomes equal to b in both cases of the operation buttons 40A and 40B.

As explained above, for both of the operation buttons 40A and 40B, the distance from the support portion 41 to the protrusion 43 is equal and the distance from the depression face 44 to the switch depression face 22 is also equal. Hence, as viewed from the Z axis direction, the shifted level of the protrusion 43 from the center of the switch depression face 22 (i.e., the shifted level of the protrusion 43 of the depression face 44 relative to the center of the switch depression face 22) is equal. Accordingly, the travel distance from the depression face 44 to the switch depression face 22 is also equal.

A comparison will be given of cases in which the user depresses the operation button 40A and the operation button 40B, respectively. Since protrusions 43 of respective operation buttons 40A and 40B are disposed so as to be shifted from the centers of respective operation portions 42, the travel distance until the depression face 44 reaches the switch depression face 22 becomes equal, and thus the travel distance necessary for operating each operation button 40 is equal.

That is, even if the operation portion 42 is disposed so as to be shifted from the center of the switch 21, the user can operate the operation buttons 40 without feeling strangeness originating from the difference in the travel distance necessary for operating each operation button 40.

In the present embodiment, the explanation was given of examples which are two operation buttons 40, but for all operation buttons 40, respective protrusions 43 are disposed so as to be shifted from the centers of respective operation portions 42 based on respective distances from the support portion 41 to the operation portion 42 in order to make the travel distance necessary for the depression face 44 to reach the switch depression face 22 is set to be equal (including a case in which the travel distance is substantially equal).

As explained above, the switch device 1 of the present embodiment has the equal travel distance necessary for operating all operation buttons 40. Hence, even if the operation buttons 40 are laid out with the design property being enhanced, the user can operate the switch device 1 without feeling strangeness.

### Modified Examples

The present invention was explained above together with embodiments, but the present invention is not limited to the above-explained embodiments, and can be changed and modified in various forms. For example, in the above embodiments, the explanation was given of the operation button 40 including the front-frame cover 30, the support portion 41 integrated therewith, and other remaining portions, but the present invention is not limited to this configuration. The operation portion 42 may be formed of a non-rigid material like a rubber, and such an operation portion 42 may be laid out on the front-frame cover 30.

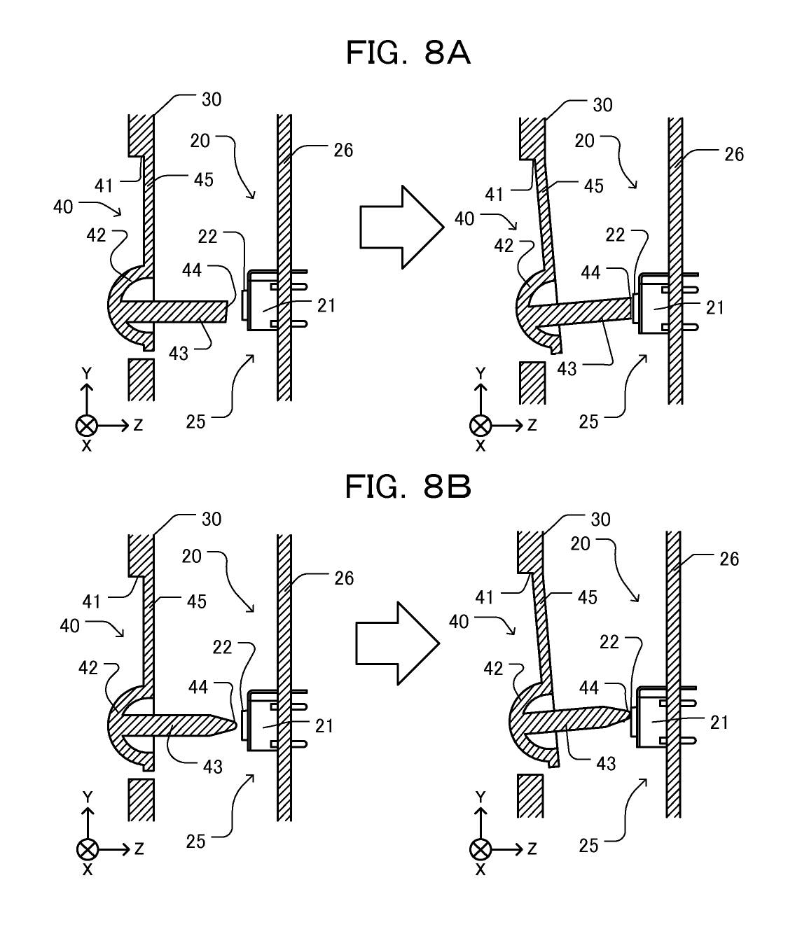

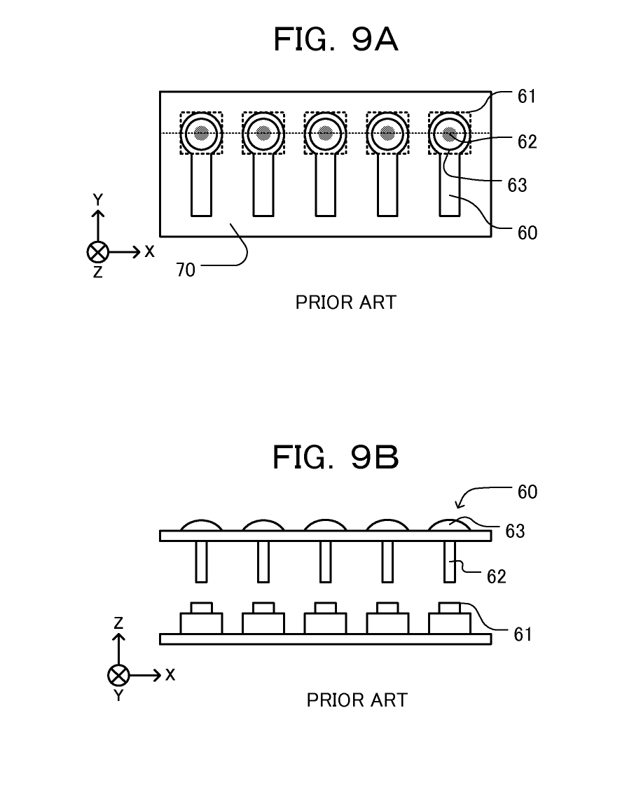

Moreover, as shown in FIG. 8A, the operation button 40 of the above-explained embodiment may have the depression face 44 that is an inclined surface.

If this configuration is employed, when the operation button 40 is depressed and the depression face 44 and the switch depression face 22 abut with each other, the depression face 44 and the switch depression face 22 abut with each other in parallel therewith, and thus depression force necessary for an operation is further equalized.

Furthermore, as shown in FIG. 8B, the operation button 40 may have a rounded depression face 44.

If this configuration is employed, when the operation button 40 is depressed and the depression face 44 and the switch depression face 22 abut with each other, the depression face 44 contacts the switch depression face 22 in a point-contact manner, and thus depression force necessary for an operation is further equalized.

The explanation was given of the example case in which the five operation buttons 40 are laid out on the front-frame cover 30 in the above-explained embodiments in order to facilitate understanding, but the present invention is not limited to this configuration. It is appropriate if at least equal to or greater than two operation buttons 40 are laid out.

In the above-explained embodiments, although shifting of the protrusion 43 relative to the switch 21 in the X axis direction or in the Y axis direction is not mentioned, but it is appropriate as long as the depression face 44 is placed at a position where the depression face 44 can abut the switch depression face 22, and such a position is not limited to any particular location. However, when the depression face 44 is shifted so as to abut the center of the switch depression face 22, depression force necessary for an operation is further equalized.

The front-frame cover 30 and the operation buttons 40 of the above-explained embodiments are each formed of a synthetic resin, but the material thereof is not limited to the above-explained embodiments. For example, those parts may be formed of a metal.

According to the above-explained embodiments and modified examples, even if the operation buttons are laid out with the design property being enhanced, the user can depress, for example, two operation buttons without feeling strangeness therebetween.

The present invention can be changed and modified in various forms without departing from the broad scope and spirit of the present invention. The above-explained embodiments and modified examples are for explanation only, and not for limiting the scope and spirit of the present invention.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A switch device comprising:
an electronic circuit board comprising an electronic circuit including a first switch and a second switch; and
a cover which covers the electronic circuit board and which includes a first operation button and a second operation button corresponding to the first switch and the second switch, respectively,
the first switch comprising a first depression face to which a first depression force is applied in a direction orthogonal to a surface of the electronic circuit board, and the first switch being configured to change an electrical connection in the electronic circuit when a predetermined depression force is applied to the first depression face,
the second switch comprising a second depression face to which a second depression force is applied in a direction orthogonal to the surface of the electronic circuit board, and the second switch being configured to change an electrical connection in the electronic circuit when the predetermined depression force is applied to the second depression face,
the first operation button comprising: a first support point integrated with the cover; a first operation portion to which a depression operation is given by a user; a first tiltable portion which has one end connected to the first support portion, has another end connected to the first operation portion, and is tilted together with the first operation portion in accordance with the depression operation given to the first operation portion; and a first protrusion that depresses the first depression face upon tilting of the first tiltable portion,
the second operation button comprising: a second support point integrated with the cover; a second operation portion to which a depression operation is given by the user; a second tiltable portion which has one end connected to the second support portion, has another end connected to the second operation portion, and is tilted together with the second operation portion in accordance with the depression operation given to the second operation portion; and a second protrusion that depresses the second depression face upon tilting of the second tiltable portion,
the first and second operation portions being depressed in a direction orthogonal to the surface of the electronic circuit board,
at least the first operation portion being shifted relative to a center of the first switch, and
travel distances or depression forces of the depression operation necessary for respective first and second protrusions to reach respective first and second depression faces being equal to each other.

2. The switch device according to claim 1, wherein
the first tiltable portion and the second tiltable portion have different lengths, and
respective dimensions of the first and second protrusions along a direction orthogonal to the surface of the electronic circuit board differ in accordance with the length of the first tiltable portion and the length of the second tiltable portion.

3. The switch device according to claim 1, wherein a shifted level of the first protrusion from a center of the first depression face and a shifted level of the second protrusion from a center of the second depression face are equal to each other.

4. The switch device according to claim 1, wherein a tip of the first protrusion is formed in an inclined surface so as to abut the depression face in parallel therewith when depressing the depression face.

5. The switch device according to claim 2, wherein a tip of the first protrusion is formed in an inclined surface so as to abut the depression face in parallel therewith when depressing the depression face.

6. The switch device according to claim 3, wherein a tip of the first protrusion is formed in an inclined surface so as to abut the depression face in parallel therewith when depressing the depression face.

7. The switch device according to claim 1, wherein respective tips of the first and second protrusions are rounded.

8. The switch device according to claim 2, wherein respective tips of the first and second protrusions are rounded.

9. The switch device according to claim 3, wherein respective tips of the first and second protrusions are rounded.
